(19) United States
(12) Patent Application Publication
(10) Pub. No.: US 2017/0290378 A1
(43) Pub. Date: Oct. 12, 2017

(54) COLDNESS-PREVENTING PROTECTIVE CLOTHING

(71) Applicant: SEKURA CORPORATION, Hasuda-shi (JP)

(72) Inventor: Norio SEKURA, Hasuda-shi (JP)

(73) Assignee: SEKURA CORPORATION, Hasuda-shi (JP)

(21) Appl. No.: 15/507,832

(22) PCT Filed: Jun. 1, 2015
(86) PCT No.: PCT/JP2015/002760

§ 371 Date: Mar. 1, 2017

(30) Foreign Application Priority Data
Oct. 1, 2014 (JP) 2014-005246

(51) Int. Cl. A41D 13/002; A41D 13/02; A41D 31/00

(52) U.S. Cl. CPC A41D 13/002; A41D 31/0038; A41D 13/02; G21F 3/02

(57) ABSTRACT

[Task] An object is to provide coldness-preventing protective clothing that can be manufactured at low cost and is lightweight and comfortable to wear.

[Means for Resolution] Coldness-preventing protective clothing is formed in the form of a working wear by using a sheet-shaped base material formed by joining either of a lattice-shaped, net-shaped, linear, or point-like foamed body or a sheet-shaped foamed body having at least one of a concave portion and a hole, or a combination of two or more of these foamed bodies, to cloth made of a nonwoven fabric, a net fabric, an air-permeable film, or an airtight film.

### TECHNICAL FIELD

The present invention relates to protective clothing which is lightweight and comfortable to wear and has cold protection performance.

### BACKGROUND ART

In a nuclear facility or the like, in a place where minor radiation is detected, protective clothing made of a nonwoven fabric is used in a so-called disposable manner.

Since the protective clothing made of a nonwoven fabric is formed mainly of a nonwoven fabric, it can be manufactured at low cost, and accordingly, in terms of being capable of being supplied at a low price, it is widely used as disposable protective clothing. However, since it is made of a nonwoven fabric, it has little cold protection performance.

Protective clothing having cold protection performance is often formed using a sheet-shaped material having a multilayer structure made of chemical fibers or the like as a base fabric, as seen in PTLs 1 to 4 and the like. However, the base fabric has a multilayer structure, and therefore, the base fabric itself is expensive, and it is reflected in the price of the protective clothing, which is significantly more expensive than the protective clothing made of a nonwoven fabric.

If the high-price protective clothing having cold protection performance, as described above, is used in a disposable manner, the cost associated with it becomes enormous. Therefore, the applicant of this application proposed low-cost coldness-preventing protective clothing by using a sheet-shaped foamed body having cold protection performance. However, there is a case where this coldness-preventing protective clothing is heavy and is not comfortable to wear.

### CITATION LIST

### Patent Literature

[PTL 1] Japanese Patent No. 4258816

[PTL 2] Japanese Patent No. 3768359

[PTL 3] JP-A-2011-184806

[PTL 4] JP-A-2010-261133

### SUMMARY OF INVENTION

### Technical Problem

Therefore, the present invention has an object to provide coldness-preventing protective clothing which can be manufactured at low cost and is lightweight and comfortable to wear.

### Solution to Problem

Coldness-preventing protective clothing according to an aspect of the present invention which has been made in order to solve the above-mentioned problem has a configuration formed in the form of a working wear by using a sheet-shaped base material formed by joining either of a lattice-shaped, net-shaped, linear, or point-like foamed body or a sheet-shaped foamed body having at least one of a concave portion and a hole, or a combination of two or more of these foamed bodies, to cloth made of a nonwoven fabric, a net fabric, an air-permeable film, or an airtight film.

In this manner, a sheet-shaped base material is formed by joining a foamed body having cold protection performance, which can be molded at low cost, to cloth such as a nonwoven fabric which can be formed at low cost, and protective clothing exhibiting the form of a coverall type working wear or a two-piece type working wear is formed by using the sheet-shaped base material, for example, with the cloth being an outer surface and the foamed body being on the inner surface side. Therefore, the protective clothing can obtain cold protection performance due to a foam layer, and moreover, since such protective clothing can be manufactured at very low cost, it is very useful as so-called disposable type coldness-preventing protective clothing. Further, it is lighter and more comfortable to wear than in a case where a sheet-shaped foamed body having a uniform thickness is joined to the entire surface of cloth, and therefore, it is possible to attain a reduction in the weight of the coldness-preventing protective clothing and improve wear comfort as well.

Further, coldness-preventing protective clothing according to another aspect of the present invention, in which it is possible to solve the above-mentioned problem, has a configuration in which a foamed body is provided between an outer material and a lining material each made of a nonwoven fabric, a net fabric, an air-permeable film, or an airtight film with an outer shape arranged for a working wear, and the foamed body is either of a lattice-shaped, net-shaped, linear, or point-like foamed body or a sheet-shaped foamed body having at least one of a concave portion and a hole, or a combination of two or more of these foamed bodies, and is joined or entangled to either of the outer material or the lining material, or both the outer material and the lining material.

Even with such a configuration, similar to the above, coldness-preventing protective clothing which can be manufactured at low cost and is lightweight and comfortable to wear is obtained.

In this case, the outer material can be formed of an airtight film and the lining material can be formed of an air-permeable material.

Further, in the present invention, as the foamed body, when it is intended for waterproofing in addition to cold protection, a closed cell foamed body can be used, and when it is intended for ventilation in addition to cold protection, an open cell foamed body can be used.

### Advantageous Effects of Invention

According to the present invention, coldness-preventing protective clothing which can be manufactured at low cost and is lightweight and comfortable to wear can be obtained.

### BRIEF DESCRIPTION OF DRAWINGS

FIG. 1 is a cross-sectional view schematically showing an example of a sheet-shaped base material which is used in first coldness-preventing protective clothing according to the present invention.

FIG. 2 is a front view of an example of coverall type protective clothing according to the present invention.

FIG. 3 is a front view of an example of two-piece type protective clothing according to the present invention.

FIG. 4 is a cross-sectional view schematically showing an example of an outer material, a lining material, and a foamed body which are used in second coldness-preventing protective clothing.

### DESCRIPTION OF EMBODIMENTS

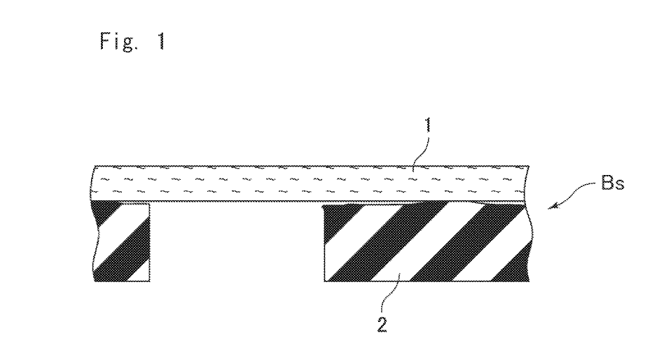

Hereinafter, an embodiment of coldness-preventing protective clothing according to the present invention will be described based on the accompanying drawings. As shown in FIGS. 1 to 3, coldness-preventing protective clothing A of a first example of this embodiment is formed in the form of a working wear by using a sheet-shaped base material Bs formed by joining a foamed body 2 to cloth 1 such as nonwoven fabric. The foamed body 2 is provided to be positioned at a predetermined site of a working wear according to the balance between a cold protection ability and a wearing ability during work, or according to a site, there is a case where the foamed body is not provided.

The cloth 1 is a nonwoven fabric, a net fabric, an air-permeable film, an airtight film, or the like. The nonwoven fabric is formed by using, for example, a propylene-based resin fiber by a conventional method such as a needle punching method, and specifically, as one example, a laminate type nonwoven fabric in which a polyester-based nonwoven fabric is laminated on a polypropylene-based resin nonwoven fabric can also be used. Further, as the cloth 1, cloth formed into a net fabric or a fabric by using yarns made of the above-described resin material or other resin materials can be used singly or along with a nonwoven fabric. Further, as the cloth 1, an air-permeable film or an airtight film can be used singly or along with the nonwoven fabric or the fabric.

As the foamed body 2, a polypropylene-based foamed body, a polyethylene-based foamed body, a polyester-based foamed body, a nylon-based foamed body, or the like can be used. Here, as an example, it is possible to use a foamed body 2 obtained by foaming a propylene-based resin simple substance, or a resin material, in which any of ethylene-based resin, butene-based resin, vinyl chloride-based resin such as polyvinyl chloride, and styrene-based resin is mixed with the propylene-based resin, into a closed cell or an open cell with an expansion ratio in a range of 10 times to 100 times, for example. Further, as the above-described resin material, either of a crosslinked resin material or a non-crosslinked resin material can be used.

As the foamed body 2, either of a lattice-shaped, net-shaped, linear, or point-like foamed body or a sheet-shaped foamed body having at least one of a concave portion and a hole in the surface thereof, or a combination of two or more of these foamed bodies can be used. As the lattice-shaped foamed body or the net-shaped foamed body, there is no particular limitation and each of the foamed bodies can be formed in an arbitrary shape. As the linear foamed body, it is not particularly limited to a straight line shape, a curved line shape, a combined shape of a straight line and a curved line, an elongated shape, or the like, and it can be formed in an arbitrary shape. As the point-like foamed body, it is not particularly limited to a circular shape, a triangular shape, a quadrangular shape, other polygonal shapes, or the like, and it can be formed in an arbitrary shape. In the sheet-shaped foamed body having at least one of a concave portion and a hole, the shape of each of the concave portion and the hole is not particularly limited to a circular shape, a triangular shape, a quadrangular shape, other polygonal shapes, or the like, and it can be formed in an arbitrary shape. Further, the sheet-shaped foamed body having a concave portion in the surface thereof is a sheet-shaped foamed body having a surface formed in a concavo-convex shape.

It is preferable that the sheet-shaped foamed body has a thickness in a range of 0.1 mm to 3 mm, for example, in the case of a closed cell, and has a thickness in a range of 4 mm to 6 mm, for example, and a thickness less than or equal to 10 mm at the maximum, in the case of an open cell. It is preferable that the foamed body 2 is disposed at a selected site of the cloth 1 so as not to impair a wearing ability during work when performing work with wearing the protective clothing, or is formed such that the position of the concave portion or the hole does not impair a wearing ability during work. For example, the elongated foamed bodies 2 extending in an up-and-down direction may be provided at intervals in a width direction on the front face corresponding to the abdomen and the chest or the rear face corresponding to the back, of a working wear, or the sheet-shaped foamed body 2 with a slit-like hole extending in an up-and-down direction formed therein may be provided on the front face corresponding to the abdomen and the chest or the rear face corresponding to the back, of a working wear.

As a method of joining the foamed body 2 to the cloth 1, a method of bonding them together by interposing a hot-melt type adhesive between them, a laminating method, or other bonding methods can be used. Further, in a case where both the cloth 1 and the foamed body 2 are formed of propylene-based resin, they can be joined together by thermal welding without using an adhesive. Further, as a method of joining the cloth 1 and the foamed body 2 to each other, there is also a joining aspect in which the cloth 1 and the foamed body 2 are joined by sewing, for example, the cloth 1 and the foamed body 2 are sewn in a quilting manner. A location where the foamed body 2 is joined to the cloth 1 may be either a portion or the whole area of the surface (joining surface) that can be joined to the cloth 1, of the foamed body 2. FIG. 1 shows an example in which a portion of the joining surface of the net-shaped foamed body 2 is joined to the cloth 1.

Further, the laminate of the cloth 1 and the foamed body 2 in the present invention is not limited to a laminate having a two-layer configuration in the example of FIG. 1 and shall include, for example, a laminate having at least three-layer configuration that is an aspect in which the foamed body 2 is sandwiched between the front and the back. Further, as the lamination of the cloth 1 and the foamed body 2, there is also a lamination by entanglement in addition to the above-described joining. As the lamination of the cloth 1 and the foamed body 2 in the present invention, there is also an aspect in which the joining and the entanglement are used together.

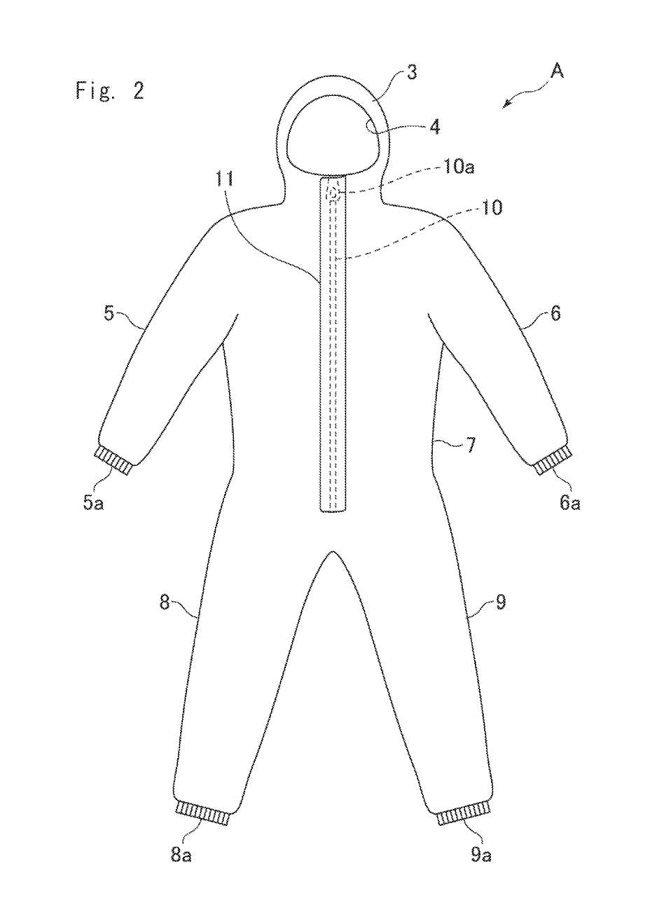

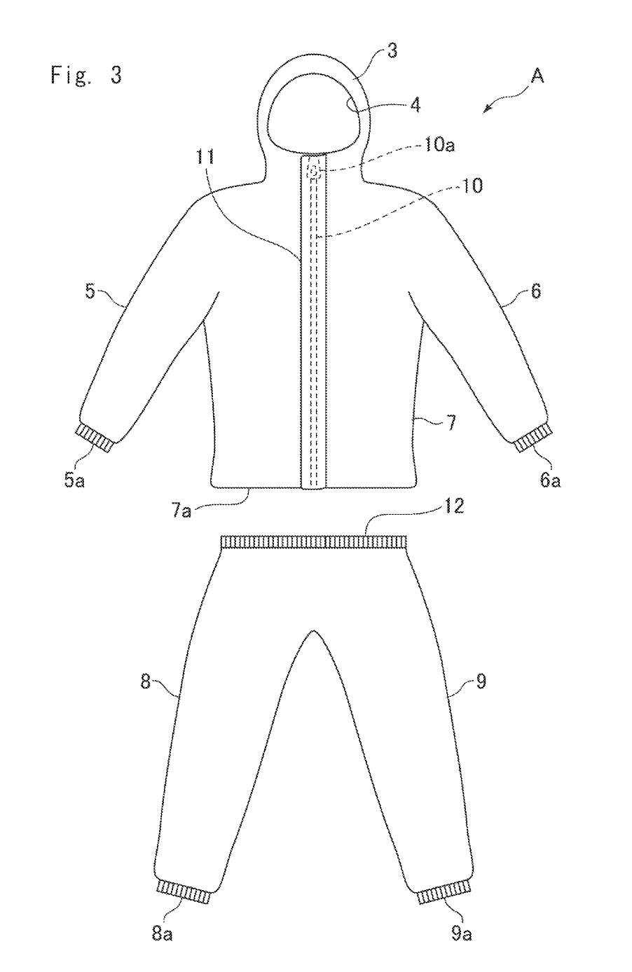

The sheet-shaped base material Bs shown as an example in FIG. 1, which is used in the present invention, is formed by a laminate in which the cloth 1 and the foamed body 2 are laminated by joining or entanglement, as described above. The sheet-shaped base material Bs is formed into an example of the coldness-preventing protective clothing A according to the present invention shown in FIG. 2 or 3, by being cut along pattern paper for protective clothing and sewn, similar to cloth for normal clothes sewing.

FIG. 2 is an external view from the front of an example of the coverall type coldness-preventing protective clothing A according to the present invention formed by cutting the sheet-shaped base material Bs of FIG. 1 into each part piece along pattern paper of a coverall type working wear shape and sewing the respective parts by an ordinary method.

In FIG. 2, reference numeral 3 denotes a hood, 4 denotes a window hole for the face, 5 and 6 denote right and left sleeves, 7 denotes a body portion, 8 and 9 denote right and left leg tubes of a pants portion formed to be continuous from a lower end portion of the body portion 7, and 10 denotes a line fastener covered with a cover piece 11 and provided with a slider 10a.

Further, throttle portions 5a and 6a and throttle portions 8a and 9a each using rubber, a cord, a double-sided tape, or the like are respectively formed at lower end portions of both the right and left sleeves 5 and 6 and lower ends of both the right and left tubes 8 and 9 of the pants portion. Overshoe portions (not shown) for covering shoes worn by a wearer are often formed at the lower ends of both the tubes 8 and 9 of the pants portion.

The coldness-preventing protective clothing A according to the present invention shown in FIG. 3 is coldness-preventing protective clothing formed into a two-piece type in which the coverall type shown in FIG. 2 is divided into a jacket and a pants, and accordingly, the same sites and members as those in FIG. 2 are denoted by the same reference numerals. In FIG. 3, reference numeral 7a denotes a hem portion of the body portion 7 in the jacket, and 12 denotes a waist belt portion in the pants.

The coldness-preventing protective clothing A according to the present invention formed as described above has the same form as that of known protective clothing, and therefore, it is worn and taken off in the same manner as the known protective clothing. However, the coldness-preventing protective clothing A is formed by using the sheet-shaped base material Bs formed by laminating and integrating the foamed body 2 on the cloth 1 and illustrated in FIG. 1, and therefore, the inside of the protective clothing and the outside air outside the clothing can be thermally isolated from each other due to the heat insulating effect by the foamed body 2.

The first coldness-preventing protective clothing A according to the present invention is as described above and is formed into the protective clothing A exhibiting the form of a coverall type working wear or a two-piece type working wear by using a sheet-shaped base material formed by joining the foamed body 2 which can be molded at low cost and has cold protection performance to the cloth 1 which can be formed at low cost, for example, with the cloth 1 being an outer surface and the foamed body 2 being on the inner surface side, and therefore, the protective clothing A can obtain the cold protection performance due to the foamed body 2. Moreover, the protective clothing A can be manufactured at very low cost, and therefore, it is very useful as so-called disposable type coldness-preventing protective clothing. Further, it is lighter and more comfortable to wear than in a case where the sheet-shaped foamed body 2 having a uniform thickness is joined to the entire surface of the cloth 1, and therefore, it is possible to attain a reduction in the weight of the coldness-preventing protective clothing and improve wear comfort as well.

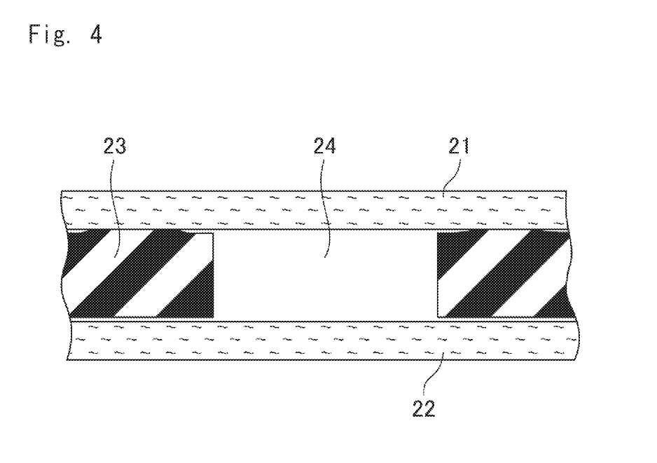

FIG. 4 is a diagram showing an example of an outer material, a lining material, and a foamed body which are used in the coldness-preventing protective clothing A of a second example of this embodiment. As shown in FIG. 4, the second coldness-preventing protective clothing A is coldness-preventing protective clothing in which a foamed body 23 is provided between an outer material 21 and a lining material 22, in which outer shapes are arranged for a working wear.

As each of the outer material 21 and the lining material 22, the cloth 1 of the first coldness-preventing protective clothing A can be used. That is, each of the outer material 21 and the lining material 22 is a nonwoven fabric, a net fabric, an air-permeable film, an airtight film, or the like. The outer material 21 and the lining material 22 may be the same cloth and may be different cloths. However, it is preferable that the outer material 21 is an airtight film and the lining material 22 is, for example, a nonwoven fabric, a net fabric, or an air-permeable film, that is, an air-permeable material.

As the foamed body 23, the foamed body 2 of the first coldness-preventing protective clothing A can be used. That is, as the foamed body 23, either of a lattice-shaped, net-shaped, linear, or point-like foamed body or a sheet-shaped foamed body having at least one of a concave portion and a hole, or a combination of two or more of these foamed bodies can be used. The foamed body 23 is joined or entangled to either of the back surface of the outer material 21 or the surface of the lining material 22, or both the surfaces . As a method of joining the foamed body 23 to the outer material 21 or the lining material 22, the same method as the method of joining the foamed body 23 to the cloth 1 of the first coldness-preventing protective clothing A can be used. Further, as a method of entangling the outer material 21 or the lining material 22 and the foamed body 23, an arbitrary entanglement method can be used. Further, FIG. 4 shows an example in which a portion of the joining surface of the net-shaped foamed body 22 is joined to the outer material 21.

The outer material 21 and the lining material 22 are formed into an example of the coldness-preventing protective clothing A as shown in FIG. 2 or 3 by being cut along pattern paper for protective clothing and sewn, for example, like cloth for normal clothes sewing, similar to the first coldness-preventing protective clothing A. At this time, it is preferable to form the coldness-preventing protective clothing A such that an air layer 24 is formed between the outer material 21 and the lining material 22.

The second coldness-preventing protective clothing A formed in this manner has the same form as that of known protective clothing, and therefore, it is worn and taken off in the same manner as the known protective clothing. However, the foamed body 23 is joined to either of the outer material 21 or the lining material 22, or both the outer material 21 and the lining material 22, and therefore, the inside of the protective clothing and the outside air outside the clothing can be thermally isolated from each other due to the heat insulating effect by the foamed body 23. Further, the air layer 24 is formed between the outer material 21 and the lining material 22, whereby the air layer acts as a heat insulating effect, and therefore, the second coldness-preventing protective clothing A has higher cold protection performance.

The second coldness-preventing protective clothing A is as described above and is formed into protective clothing exhibiting the form of a coverall type working wear or a two-piece type working wear by joining the foamed body 23 which can be molded at low cost and has cold protection performance to the outer material 21 and the lining material 22 which can be formed at low cost, and therefore, the protective clothing A can obtain the cold protection performance due to the foamed body 23. Moreover, the protective clothing A can be manufactured at very low cost, and therefore, it is very useful as so-called disposable type coldness-preventing protective clothing. Further, it is lighter and more comfortable to wear than in a case where a sheet-shaped foamed body having a uniform thickness is joined to the entire surface of the cloth, and therefore, it is possible to attain a reduction in the weight of the coldness-preventing protective clothing and improve wear comfort as well.

Further, in the second coldness-preventing protective clothing, the air layer 24 is formed between the outer material 21 and the lining material 22, whereby it is possible to increase the cold protection performance. Furthermore, if the outer material 21 is an airtight film and the lining material 22 is an air-permeable material such as a nonwoven fabric, air in the air layer 24 can escape through the lining material 22. For this reason, when the body is bent during work or the like and thus the air layer 24 is pressed with the body, air in the air layer 24 escapes through the lining material 22, and therefore, it is not necessary to worry about the rupture of the outer material or the lining material that forms the air layer 24.

### REFERENCE SIGNS LIST

1: cloth

2: foamed body

21: outer material

22: lining material

23: foamed body

24: air layer

A: coldness-preventing protective clothing

Bs: sheet-shaped base material

1. Coldness-preventing protective clothing formed in the form of a working wear by using a sheet-shaped base material formed by joining or entangling a lattice-shaped, net-shaped, linear, or point-like foamed body, a sheet-shaped foamed body having at least one of a concave portion and a hole, or a combination of at least two foamed bodies, to a surface of cloth made of a nonwoven fabric, a net fabric, an air-permeable film, or an airtight film.

2. Coldness-preventing protective clothing comprising: a foamed body provided between an outer material and a lining material each made of a nonwoven fabric, a net fabric, an air-permeable film, or an airtight film with an outer shape arranged in the form of a working wear,
wherein the foamed body is a lattice-shaped, net-shaped, linear, or point-like foamed body, a sheet-shaped foamed body having at least one of a concave portion and a hole, or a combination of at least two foamed bodies, and is joined or entangled to either of the outer material or the lining material, or both the outer material and the lining material.

3. The coldness-preventing protective clothing according to claim 1, wherein the foamed body which is joined or entangled to the cloth or at least one of the outer material and the lining material is disposed at a site which does not impair a wearing ability during work with wearing the coldness-preventing protective clothing formed of the cloth or the outer material and the lining material.

4. The coldness-preventing protective clothing according to claim 2, wherein the outer material is formed of an airtight film, and the lining material is formed of an air-permeable material.

5. The coldness-preventing protective clothing according to claim 1, wherein the foamed body is a closed cell foamed body or an open cell foamed body.

6. The coldness-preventing protective clothing according to claim 1, wherein the form of a working wear is a coverall type working wear or a two-piece type working wear divided into a jacket and a pants.

7. The coldness-preventing protective clothing according to claim 2, wherein the foamed body which is joined or entangled to the cloth or at least one of the outer material and the lining material is disposed at a site which does not impair a wearing ability during work with wearing the coldness-preventing protective clothing formed of the cloth or the outer material and the lining material.

8. The coldness-preventing protective clothing according to claim 2, wherein the foamed body is a closed cell foamed body or an open cell foamed body.

9. The coldness-preventing protective clothing according to claim 2, wherein the form of a working wear is a coverall type working wear or a two-piece type working wear divided into a jacket and a pants.
